(19) United States
(12) Patent Application Publication
(10) Pub. No.: US 2002/0174057 A1
(43) Pub. Date: Nov. 21, 2002

(54) Web trading system integrated with a major window control mechanism of a virtual hub web

(75) Inventor: Hui Chuan Lin, Taipei (TW)

Correspondence Address: MERCHANT & GOULD PC, P.O. BOX 2903, MINNEAPOLIS, MN, 55402-0903, US

(73) Assignee: Mitac International Corp., Hsinchu (TW)

(21) Appl. No.: 10/138,125

(22) Filed: May 2, 2002

(30) Foreign Application Priority Data
May 18, 2001 (TW) 90111915

(51) Int. Cl. G06F 17/60

(52) U.S. Cl. 705/37

(57) ABSTRACT

A web trading system integrated with a major window control mechanism of a virtual hub web is disclosed to allow a plurality of vendors to register, check and transmit data. The hub web contains at least: a privilege maintenance unit as a mechanism for maintaining functions and passwords; a user control unit for new account applications and tracking user changes; and a message processing unit for receiving E-mail. The major window is used to control trading data of the vendors.

### BACKGROUND OF THE INVENTION

1. Field of Invention

The invention relates to a B2B E-business web trading system and, more particularly, to a web trading system integrated with a major window control mechanism of a virtual hub web used in the SCM (Supply Chain Management) in the electronics manufacturing industry.

2. Related Art

Current B2B E-business development mainly discusses how to do business over a network. The electronics manufacturing industry faces every day problems such as what materials to purchase, how to plan production procedures once the materials are bought, how to ship finished products, and how to manage and control stocks left in the warehouses. For instance, the capacity forecast from the customer orders does not equal to official orders. Even official orders may be changed from time to time. Therefore, there are often problems such as wrong work orders, incorrect material preparation, thus resulting in material shortage or over stocking.

Traditional electronics manufacturers always have production waste due to the lack of systematic management, organization, and classification in stocking conditions, affecting enterprise material distributions, financial and stock planning. To solve the problems of over or under stocking in the electronics manufacturing industry, the only solution is to start from the bottom, namely from reducing stocks and controlling stocking conditions.

Providing electronics manufacturers current products and stocking data management is the only way to resolve the stocking problem. Thus, a web trading system with a control mechanism for the electronics manufacturing industry to have an integrated electronic trading platform is a key issue. It is therefore highly desirable to build a digital electronics manufacturer supply chain trading market between vendors and customers using network technologies.

### SUMMARY OF THE INVENTION

The specification discloses a web trading system integrated with a major window control mechanism of a virtual hub web. A hub web is utilized to allow a plurality of vendors to register, check and transmit data. The hub web contains at least: a privilege maintenance unit as a mechanism for maintaining functions and passwords; a user control unit for new account applications and tracking user changes; and a message processing unit for receiving E-mail. A major window is used to control trading data of the vendors.

Through the major window, the manufacturers and vendors can enjoy high-efficiency searches, quick transactions, and complete business services, thereby establishing an all-in-one supply chain trading system.

### BRIEF DESCRIPTION OF THE DRAWINGS

The invention will become more fully understood from the detailed description given hereinbelow illustration only, and thus are not limitative of the present invention, and wherein:

FIG. 1 is a schematic view showing the structure of the disclosed web trading system integrated with a major window control mechanism of a virtual hub web;

FIG. 2 is a schematic view showing the privileges in the web trading system in FIG. 1; and

FIG. 3 is a schematic view showing the functions in the web trading system in FIG. 1.

### DETAILED DESCRIPTION OF THE INVENTION

The invention proposes a web trading system integrated with a major window control mechanism of a virtual hub web. In this specially designed B2B E-business web site, the invention provides both parties in the business (manufacture and vendor) high-efficiency searches, quick transactions and complete business services, thus forming an all-in-one trading market. This platform combines the supplies, demands, quantities, and prices from both parties of a transaction. It integrates the supplies of its members and the needs of the manufacturers together. Through a market mechanism, an efficiency method is used to process purchases, orders, shipping and distributions, production procedures in the electronic manufacturing industry, in hope of stabilizing the market mechanism. The vendors and manufacturers post their materials demands and supplies data on the web site. Other procedures are left for the web site to process. This can increase the later section of material distribution efficiency and lower the stocking.

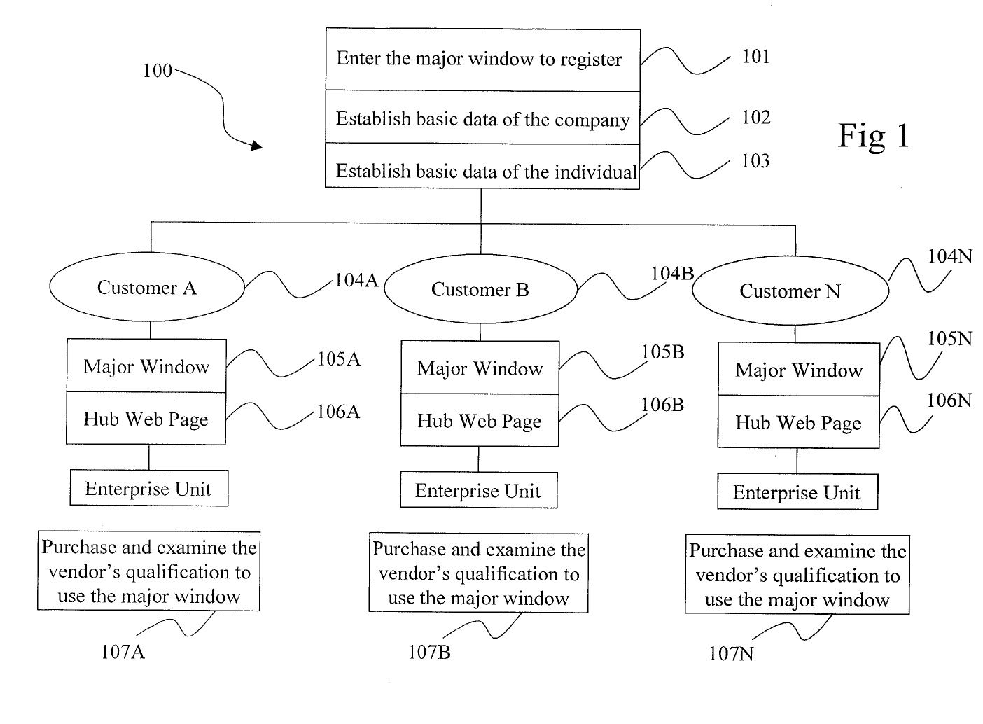

The invention proposes a web trading system integrated with a major window control mechanism of a virtual hub web. As shown in FIG. 1, a hub web 100 is provided to set up a major window 101 control mechanism for all vendors who want to use the hub web 100 when they apply for new accounts. This mechanism establishes the basic company data 102 and basic personal data 103. Besides ensuring the privacy of all data of the vendors under the hub web 100, the invention also controls the use authority of the hub web 100.

The hub web 100 provides vendors (client 1˜client N 104A˜104N) a control mechanism for the major windows 105A˜105N, accesses data for different hub web pages 106A˜1096N, and examines the qualification of vendor's uses of major windows 107A˜107N. However, the vendor system involves problems of personnel variation due to personal reasons. Suppose the manager of the major windows 105A˜105N is leaving, the vendor has to assign another person as the manager of the major windows 105A˜105N and change the password and relevant data to ensure the privacy. In addition, the authorization is made only after a purchase examination is obtained again. Analogously, personnel variations inside the vendor are also controlled by the major window 101.

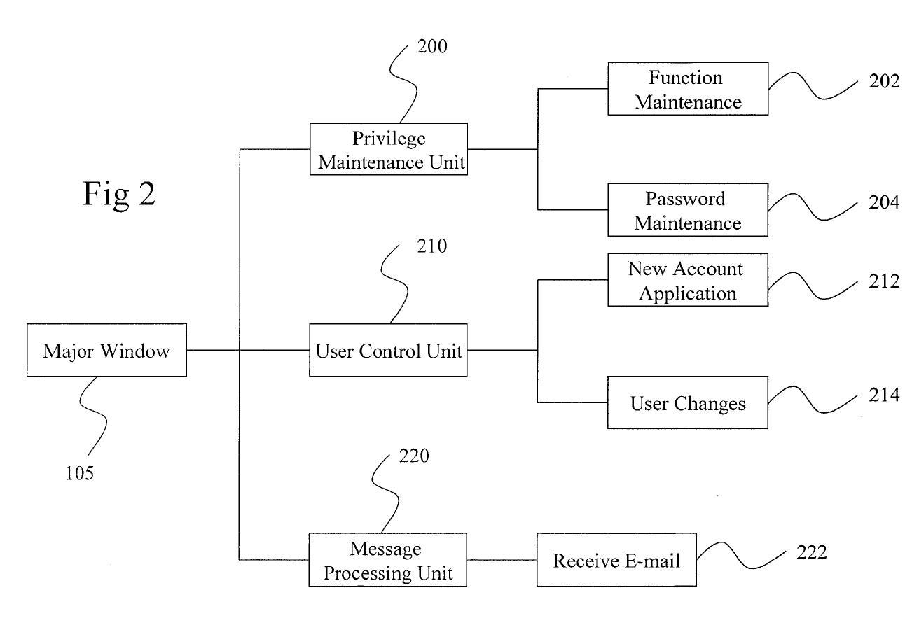

With reference to FIG. 2, the registration of the major window 105 provides a privilege maintenance unit 200, a personnel control unit 210 and a message processing unit 220.

The privilege maintenance unit 220 has the mechanisms of function maintenance 202 and password maintenance 204. The personnel control unit 210 controls new account applications 212 and personnel changes 214. The message processing unit 220 is in charge of receiving electronic mail.

The establishment of the hub web 100 can replace conventional EDI functions, reducing the EDI costs on vendors. The hub web 100 further provides vendors such mechanisms as orders, deliveries, materials reception, checking, returns, shipping, inventory, accounting, evaluation and analyses.

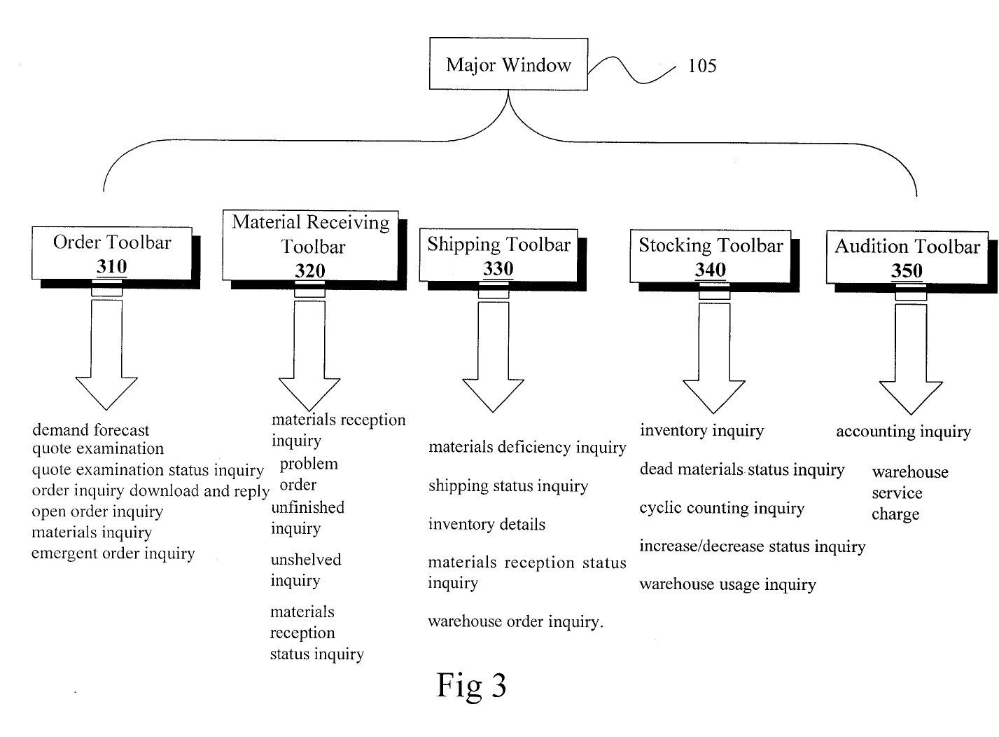

As shown in FIG. 3, the function bar of the hub web 100 includes an order function bar 310, a materials reception function bar 320, a shipping function bar 330, an inventory function bar 340, and an accounting function bar 350.

The order function bar 310 provides the following functions for vendors to perform further inquiries and deliveries of order related messages:

demand forecast;

quote examination;

quote examination status inquiry;

order inquiry download and reply;

open order inquiry;

materials inquiry; and

emergent order inquiry.

The materials reception function bar 320 provides the following functions for vendors to perform further inquiries and deliveries of materials reception related messages:

materials reception inquiry;

problem order;

unfinished inquiry;

materials reception status inquiry; and

unshelved inquiry.

The shipping function bar 330 provides the following functions for vendors to perform further inquiries and deliveries of shipping related messages:

materials deficiency inquiry;

shipping status inquiry;

inventory details;

materials reception status inquiry; and

warehouse order inquiry.

The inventory function bar 340 provides the following functions for vendors to perform further inquiries and deliveries of inventory related messages:

inventory inquiry;

dead materials status inquiry;

cyclic counting inquiry;

increase/decrease status inquiry; and

warehouse usage inquiry.

The accounting function bar 350 provides the following functions for vendors to perform further inquiries and deliveries of inventory related messages:

accounting inquiry; and

warehouse service charge.

What is claimed is:

1. A web trading system integrated with a major window control mechanism of a virtual hub web for a plurality of vendors to register, inquire, and transmit data via a hub web, wherein the hub web comprises:
a privilege maintenance unit, which provides mechanisms of function maintenance and password maintenance;
a personnel control unit, which controls new account applications and personnel changes;
a message processing unit, which is in charge of receiving E-mail (Electronic Mail); and
the major window control trading status data of each of the plurality of vendors.

2. The web trading system of claim 1 further examining the privileges of the vendors to use the major window.

3. The web trading system of claim 1, wherein the trading status data includes a mechanism selected from the group consisting of orders, deliveries, materials reception, checking, returns, shipping, inventory, accounting, evaluation and analyses.

4. The web trading system of claim 3 further including an order function bar with the functions of providing demand forecast, quote examination, quote examination status inquiry, order inquiry download and reply, opening order inquiry, materials inquiry, and emergent order inquiry.

5. The web trading system of claim 3 further including a materials reception function bar with the functions of materials reception inquiry, problem order, unfinished inquiry, materials reception status inquiry, and unshelved inquiry.

6. The web trading system of claim 3 further including a shipping function bar with the functions of materials deficiency inquiry, shipping status inquiry, inventory details, materials reception status inquiry, and warehouse order inquiry.

7. The web trading system of claim 3 further including an inventory function bar with the functions of inventory inquiry, dead materials status inquiry, cyclic counting inquiry, increase/decrease status inquiry, and warehouse usage inquiry.

8. The web trading system of claim 3 further including an accounting function with the functions of accounting inquiry and warehouse service charge.
